(19) United States
(12) Patent Application Publication
(10) Pub. No.: US 2023/0116806 A1
(43) Pub. Date: Apr. 13, 2023

(54) MOBILE TOWER SYSTEM

(71) Applicant: Gerald W. Newman, Spangle, WA (US)

(72) Inventor: Gerald W. Newman, Spangle, WA (US)

(21) Appl. No.: 17/496,544

(22) Filed: Oct. 7, 2021

(51) Int. Cl. B65D 90/12; B65D 88/02; B65D 90/00

(52) U.S. Cl. CPC B65D 90/125; B65D 88/027; B65D 90/0006; B65D 2590/0008

(57) ABSTRACT

A mobile tower system includes a steel shipping container. A tower structure is moveable between a substantially horizontal travel position and a substantially vertical operational position. A connection member is fixed to a lower portion of the tower structure and moveably coupled to a channel disposed in a horizontal member removeably attached to a vertical frame attached to a back wall of the steel shipping container. When the tower structure is displaced from the substantially horizontal travel position to the substantially vertical operational position, the connection member and the tower structure are linearly displaced together along the channel toward the back wall and the tower structure is pivotably displaced about the connection member, such that the upper portion of the tower structure is displaced through an opening disposed in a roof of the steel shipping container proximate a back wall of the steel shipping container.

### BACKGROUND

Mobile tower systems exist that include tower structures that are shipped in a supported horizontal within a shipping container, but then may be reoriented to a vertical position for the use and/or operation of the tower structures. However, these mobile tower systems are relatively bulky and cumbersome to install at remote locations. For example, the tower structure being transported can be relatively bulky and cumbersome to reorient from the horizontal travel position to the vertical operational position. Accordingly, there remains a need for mobile tower systems that are relatively easier to install at remote locations.

### SUMMARY

Mobile tower systems that may more easily be installed at remote locations are described herein. More specifically, this disclosure relates to mobile tower systems that have tower structures that are pivotably displaceable about a connection member that is moveably coupled to a structural frame inside of a steel shipping container. This summary is provided to introduce simplified concepts of mobile tower systems, which are further described below in the Detailed Description. This summary is not intended to identify essential features of the claimed subject matter, nor is it intended for use in determining the scope of the claimed subject matter.

In an embodiment, a mobile tower system includes a tower structure, having an upper portion and a lower portion, that is moveable between a substantially horizontal travel position and a substantially vertical operational position. A connection member is fixed to the lower portion of the tower structure that is moveably coupled to a structural frame. The structural frame includes a vertical frame fixed to a back wall of a shipping container and a horizontal frame removeably attached to the vertical frame. When the tower structure is positioned in the substantially vertical operational position, the vertical frame receives the lower portion of the tower structure and supports the tower structure in the substantially vertical operational position. When the tower structure is positioned in the substantially horizontal travel position the horizontal frame receives the lower portion of the tower structure and supports the tower structure in the substantially horizontal travel position. When the tower structure is displaced from the substantially horizontal travel position to the substantially vertical operational position, the connection member and the tower structure are linearly displaced together along the horizontal frame toward the back wall and the tower structure is pivotably displaced about the connection member, such that the upper portion of the tower structure is displaced through an opening disposed in a roof of the shipping container proximate the back wall of the steel shipping container.

In another embodiment, a mobile tower system includes a tower structure, having an upper portion and a lower portion, that is moveable between a substantially horizontal travel position and a substantially vertical operational position. A connection member is fixed to the lower portion of the tower structure that is moveably coupled to a channel disposed in a horizontal member removeably attached to a vertical frame attached to a back wall of the steel shipping container. When the tower structure is displaced from the substantially horizontal travel position to the substantially vertical operational position, the connection member and the tower structure are linearly displaced together along the channel toward the back wall of the steel shipping container and the tower structure is pivotably displaced about the connection member, such that the upper portion of the tower structure is displaced through an opening disposed in a roof of the steel shipping container proximate the back wall of the steel shipping container.

In another embodiment, a mobile tower system includes a tower structure, having an upper portion and a lower portion, that is moveable between a substantially horizontal travel position and a substantially vertical operational position. A roller is rotatably coupled to a pin. The pin is fixed to the lower portion of the tower structure and the roller is moveably coupled in a channel disposed in a horizontal member that is removeably attached to a vertical frame attached to a back wall of the steel shipping container. When the tower structure is displaced from the substantially horizontal travel position to the substantially vertical operational position, the roller and the tower structure are linearly displaced together along the channel toward a back wall of the steel shipping container and the tower structure is pivotably displaced about the roller, such that the upper portion of the tower structure is displaced through the opening disposed in the roof proximate the back wall of the steel shipping container.

Depending on the desired esthetic and mechanical properties of the mobile tower system components may comprise metal, plastic, and/or ceramic.

### BRIEF DESCRIPTION OF THE DRAWINGS

The detailed description is set forth with reference to the accompanying figures. In the figures, the left-most digit(s) of a reference number identifies the figure in which the reference number first appears. The use of the same reference numbers in different figures indicates similar or identical items.

FIG. 1 illustrates a top perspective view of an exemplary mobile tower system according to an embodiment in this disclosure.

FIG. 2 illustrates a side view of the mobile tower system of FIG. 1 with a tower structure in a substantially horizontal position according to an embodiment in this disclosure.

FIG. 3 illustrates a side view of the mobile tower system of FIG. 1 with the tower structure in a substantially vertical position according to an embodiment in this disclosure.

FIG. 4 illustrates a perspective view of a structural frame of the mobile tower system of FIG. 1 according to an embodiment in this disclosure.

FIG. 5 illustrates a perspective view of an example connection member according to an embodiment in this disclosure.

### DETAILED DESCRIPTION

### Overview

This disclosure is directed to mobile tower systems having a tower structure that is pivotably displaceable about a connection member that is moveably coupled to a structural frame inside of a steel shipping container. Because the tower structure is pivotably displaceable about a connection member that is moveably coupled to a structural frame inside of a steel shipping container, a user may quickly and easily install the mobile tower systems at remote locations.

### Illustrative Mobile Tower Systems

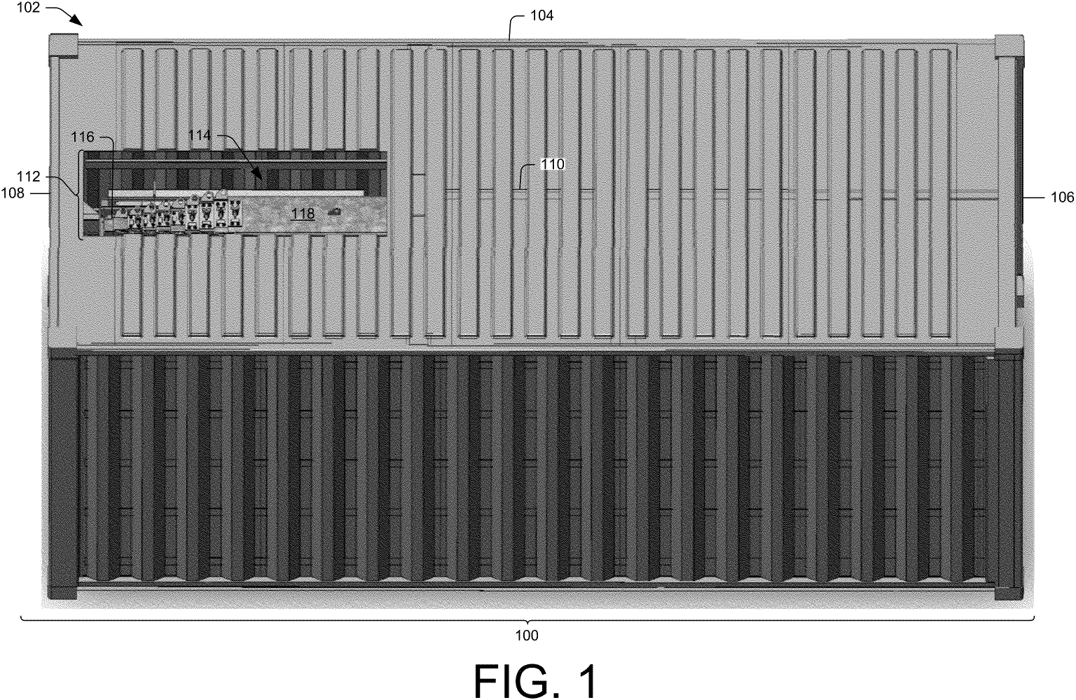

FIG. 1 illustrates a top perspective view 100 of an exemplary mobile tower system 102 according to an embodiment in this disclosure. The mobile tower system 102 may include a steel shipping container 104. The steel shipping container 104 includes a front wall 106 opposite a back wall 108, and a roof 110 extending between the front wall 106 and the back wall 108. The roof 110 has an opening 112 disposed in the roof 110 proximate the back wall 108. The mobile tower system 102 may include a cover for removeably sealing the opening 112 disposed in the roof 110.

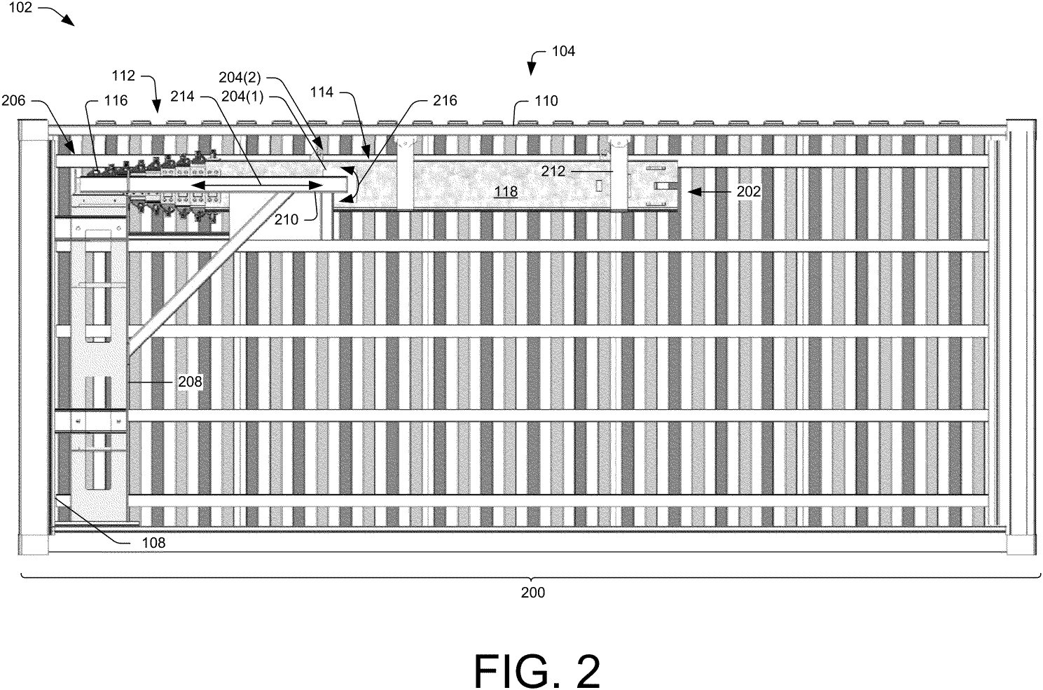

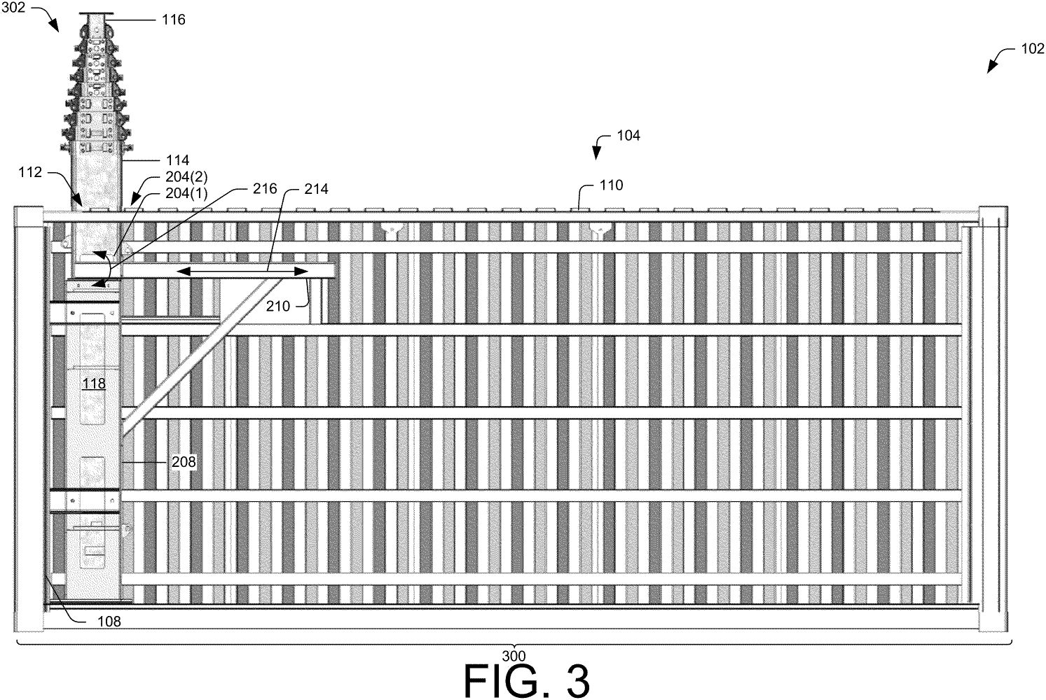

A tower structure 114 may have an upper portion 116 and a lower portion 118 that may be moveably coupled in the steel shipping container 104. The tower structure 114 may be moveably coupled in the steel shipping container 104 such that the tower structure 114 is moveable between a substantially horizontal travel position (discussed in more detail below with regard to FIG. 2) and a substantially vertical operational position (discussed in more detail below with regard to FIG. 3). For example, in an embodiment, the tower structure 114 may include a 60′ hydraulic extendable tower. In another example embodiment, the tower structure 114 may include an 80′ hydraulic extendable tower. The tower structure 114 may include a plurality of members vertically aligned between a top member and a base member. The plurality of members and the top member may each extend at least a portion of a vertical distance relative to the base member. The top member, the base member, and the plurality of members may be telescoping segments. In an embodiment, each of the top member, the base member, and the plurality of members may be rectangular tubes. The top member, the base member, and/or the plurality of members may be formed of metal (e.g., steel, aluminum, titanium, etc.), composite (e.g., carbon fiber, fiberglass, etc.), plastic, etc. The tower structure 114 may include a hydraulic cylinder mounted within the tower structure.

The steel shipping container 104 may include racks fixed on inside surfaces of the container for mounting equipment thereto. For example, solar equipment, radio equipment, wireless equipment, cell equipment, batteries, generators etc. may be mounted to racks fixed on inside surfaces of the steel shipping container 104. The steel shipping container 104 may include one or more doors to provide access to the inside of the steel shipping container 104 and/or provide access to equipment mounted inside the steel shipping container 104.

FIG. 2 illustrates a side view 200 of the mobile tower system 102 of FIG. 1 with the tower structure 114 in a substantially horizontal travel position 202 according to an embodiment in this disclosure. FIG. 2 illustrates the steel shipping container 104 with a side wall not shown for the sake of clarity and is not intended to be limiting in any manner. One or more connection members 204(1) and 204(2) may be fixed to the lower portion 118 of the tower structure 114. For example, the one or more connection members 204(1) and 204(2) may be welded to the lower portion 118 of the tower structure 114. The one or more connection members 204(1) and 204(2) may be moveably coupled to a structural frame 206.

The structural frame 206 includes a vertical frame 208 and a horizontal frame 210. The vertical frame 208 may be fixed to the back wall 108 of the steel shipping container 104 such that, when the tower structure 114 is positioned in the substantially vertical operational position, the vertical frame 208 receives the lower portion 118 of the tower structure 114 and supports the tower structure 114 in the substantially vertical operational position (discussed in more detail below with regard to FIG. 3). The horizontal frame 210 may be removably attached to the vertical frame 208. For example, the horizontal frame 210 may be bolted to the vertical frame 208. The horizontal frame 210 may be removeably attached to the vertical frame 208 such that, when the tower structure 114 is in the substantially vertical operational position, the horizontal frame 210 may be unattached from the vertical frame 208 to provide more working space inside the steel shipping container 104. The horizontal frame 210 may be removeably attached to the vertical frame 208, such that, when the tower structure 114 is positioned in the substantially horizontal travel position 202, the horizontal frame 210 receives the lower portion 118 of the tower structure 114 and supports the tower structure 114 in the substantially horizontal travel position 202. One or more removeable support structures 212 may provide additional support for the tower structure 114 when the tower structure 114 is in the substantially horizontal travel position 202. The one or more removeable support structures 212 may be removed to displace the tower structure 114 from the substantially horizontal travel position 202 to the substantially vertical operational position. In an embodiment, when the tower structure 114 is displaced from the substantially horizontal travel position 202 to the substantially vertical operational position, the one or more connection members 204(1) and 204(2) and the tower structure 114 are linearly displaced 214 simultaneously together along the horizontal frame 210 toward the back wall 108. Moreover, when the tower structure 114 is displaced from the substantially horizontal travel position 202 to the substantially vertical operational position the tower structure 114 may also be pivotably displaced about the one or more connection members 204(1) and 204(2). The one or more connection members 204(1) and 204(2) and the tower structure 114 may be linearly displaced 214 simultaneously together along the horizontal frame 210 toward the back wall 108 while the tower structure 114 is pivotably displaced 216 about the one or more connection members 204(1) and 204(2), such that the upper portion 116 of the tower structure 114 is displaced through the opening 112 disposed in the roof 110 proximate the back wall 108 of the steel shipping container 104.

FIG. 3 illustrates a side view 300 of the mobile tower system 102 of FIG. 1 with the tower structure 114 in a substantially vertical operational position 302 according to an embodiment in this disclosure. Similar to FIG. 2, FIG. 3 illustrates the steel shipping container 104 with the side wall not shown for the sake of clarity and is not intended to be limiting in any manner. FIG. 3 illustrates the vertical frame 208 receives the lower portion 118 of the tower structure 114 and supports the tower structure 114 in the substantially vertical operational position 302. When the tower structure 114 is positioned in the substantially vertical operational position 302, the tower structure is extendable a vertical distance via a hydraulic cylinder mounted within the tower structure 114. FIG. 3 illustrates when the tower structure 114 is displaced from the substantially horizontal travel position 202 to the substantially vertical operational position 302, the one or more connection members 204(1) and 204(2) and the tower structure 114 are linearly displaced 214 together along the horizontal frame 210 toward the back wall 108 and the tower structure 114 is pivotably displaced 216 about the one or more connection members 204(1) and 204(2), such that the upper portion 116 of the tower structure 114 is displaced through the opening 112 disposed in the roof 110 proximate the back wall 108 of the steel shipping container 104. One or more wenches and cables may be mounted in the steel shipping container 104 to assist in moving the tower structure 114 from the substantially horizontal travel position 202 to the substantially vertical operational position 302. As discussed above, the horizontal frame 210 may be unattached from the vertical frame 208 to provide more working space inside the steel shipping container 104.

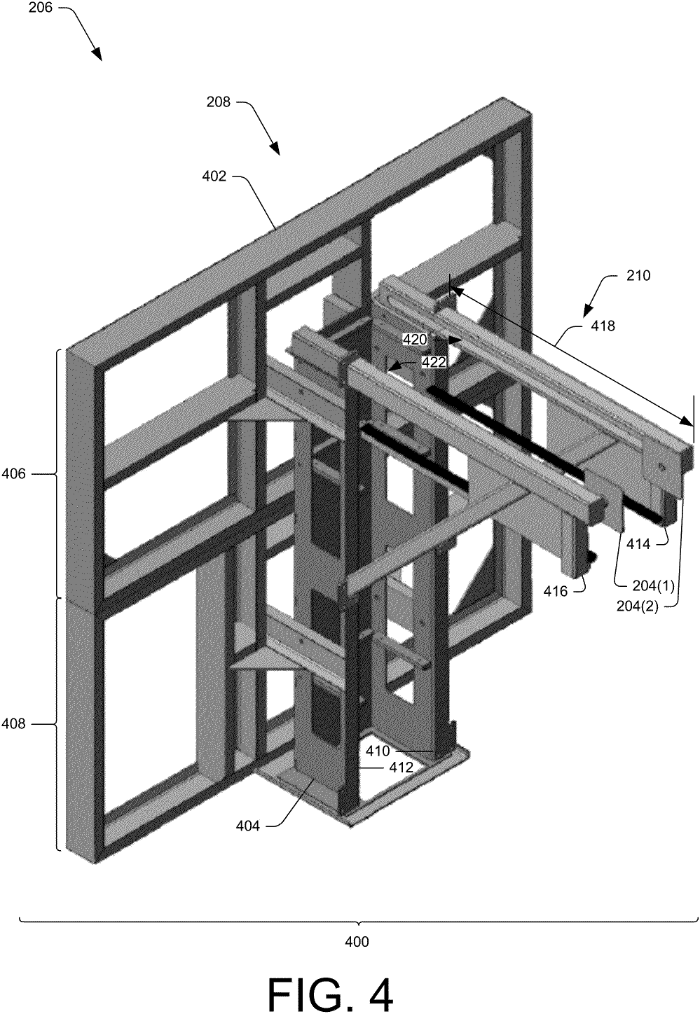

FIG. 4 illustrates a perspective view 400 of the structural frame 206 of FIG. 2 according to an embodiment in this disclosure. FIG. 4 illustrates the vertical frame 208 including a first portion 402 and a second portion 404. The first portion 402 of the vertical frame 208 may be configured to be fixed to the back wall 108 of the steel shipping container 104. For example, the first portion 402 of the vertical frame 208 may be welded to the back wall 108 of the steel shipping container 104. The first portion 402 of the vertical frame 208 may be welded to at least both of the two corner support structures of the back wall 108 of the steel shipping container 104. The first portion 402 of the vertical frame 208 may include a top portion 406 and a bottom portion 408. The top portion 406 and the bottom portion 408 may be prefabricated. The top portion 406 and the bottom portion 408 may be sized such that one or more users may carry the top portion 406 and/or the bottom portion 408 into the steel shipping container to be welded to the back wall 108 of the steel shipping container 104. The top portion 406 may be welded to an upper portion of the back wall 108 of the steel shipping container 104. The bottom portion 408 may be welded to a lower portion of the back wall 108 of the steel shipping container 104 below the top portion 406 welded to the upper portion of the back wall 108 of the steel shipping container 104. A wall (e.g., a false wall) may be used to cover the first portion 402 of the vertical frame 208 inside of the steel shipping container 104. The second portion 404 of the vertical frame 208 may be fixed to the first portion 402 of the vertical frame 208. The second portion 404 of the vertical frame 208 may be formed of a structurally continuous unit of metal such that the second portion 404 is defined by a first protrusion 410 connected in parallel to a second protrusion 412. For example, the second portion 404 of the vertical frame 208 may be formed of a structurally continuous unit of sheet metal such that the second portion 404 is defined by the first protrusion 410 connected in parallel to the second protrusion 412. When the tower structure 114 is positioned in the substantially vertical operational position 302, the lower portion 118 of the tower structure 114 is positioned in the second portion 404 of the vertical frame 208 between the first protrusion 410 and the second protrusion 412. Subsequent to positioning the tower structure 114 in the substantially vertical operational position 302, one or more brackets may be attached to the first protrusion 410 and the second protrusion 412 of the second portion 404 of the vertical frame 208. The bracket attached to the first protrusion 410 and the second protrusion 412 may hold the lower portion 118 of the tower structure 114 between the first protrusion 410 and the second protrusion 412.

FIG. 4 illustrates the horizontal frame 210 may include a first horizontal member 414 and a second horizontal member 416. The first horizontal member 414 and the second horizontal member 416 have a longitudinal length 418 extending between a first end opposite a second end. The first horizontal member 414 may include a first channel 420 disposed in the first horizontal member 414 and extends the longitudinal length 418 between the first end and the second end of the first horizontal member 414. Similarly, the second horizontal member 416 may include a second channel 422 disposed in the second horizontal member 416 and extends the longitudinal length 418 between the first end and the second end of the second horizontal member 416.

FIG. 4 illustrates the one or more connection members 204(1) and 204(2) are each moveably coupled in the first and second channels 420 and 422. The one or more connection members 204(1) and 204(2) may be moveably coupled in the first and second channels 420 and 422 such that the first and second channels 420 and 422 guide each of the one or more connection members 204(1) and 204(2) linearly along the longitudinal length 418 between the first end and the second end of the first and second horizontal members 414 and 416. For example, when the tower structure 114 is displaced from the substantially horizontal travel position 202 to the substantially vertical operational position 302, the first and second channels 420 and 422 guide each of the one or more connection members 204(1) and 204(2) linearly along the longitudinal length 418 between the first end and the second end of the first and second horizontal members 414 and 416.

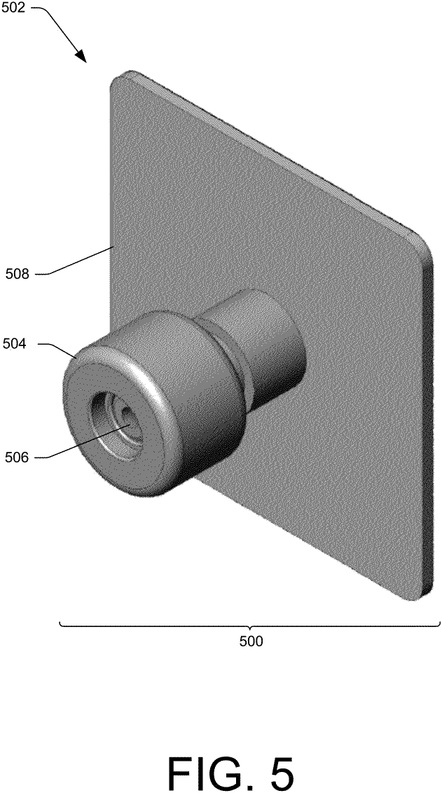

FIG. 5 illustrates a perspective view 500 of an example connection member 502 according to an embodiment in this disclosure. The connection member 502 may be the same as or similar to the one or more connection members 204(1) and 204(2) and may include a roller pin feature, such as, for example, a roller 504 rotatably attached to a pin 506. Further, the pin 506 may be fixed to a plate 508, and the roller 504 of the connection member 502 may be moveably received by the first channel 420 or the second channel 422. Moreover, the plate 508 may be fixed to the lower portion 118 of the tower structure 114. Thus, in an embodiment where the roller 504 is rotatably attached to the pin 506 and the plate 508 is fixed to the lower portion 118 of the tower structure 114, the connection member 502 and the tower structure 114 are linearly displaceable simultaneously together along the horizontal frame, and the tower structure 114 is pivotably displaceable about the roller 504 of the connection member 502.

### Conclusion

Although the invention has been described in language specific to structural features and/or methodological acts, it is to be understood that the invention is not necessarily limited to the specific features or acts described. Rather, the specific features and acts are disclosed as illustrative forms of implementing the invention. For example, while embodiments are described having certain shapes, sizes, and configurations, these shapes, sizes, and configurations are merely illustrative.

What is claimed is:

1. A mobile tower system comprising:
a steel shipping container including:
a front wall opposite a back wall, and
a roof extending between the front wall and the back wall, the roof having an opening disposed in the roof proximate the back wall;
a tower structure having an upper portion and a lower portion, the tower structure moveable between a substantially horizontal travel position and a substantially vertical operational position;
a connection member fixed to the lower portion of the tower structure, the connection member moveably coupled to a structural frame, and the structural frame including:
a vertical frame fixed to the back wall of the shipping container, such that when the tower structure is positioned in the substantially vertical operational position, the vertical frame receives the lower portion of the tower structure and supports the tower structure in the substantially vertical operational position, and
a horizontal frame removeably attached to the vertical frame, such that when the tower structure is positioned in the substantially horizontal travel position the horizontal frame receives the lower portion of the tower structure and supports the tower structure in the substantially horizontal travel position,
wherein when the tower structure is displaced from the substantially horizontal travel position to the substantially vertical operational position, the connection member and the tower structure are linearly displaced together along the horizontal frame toward the back wall and the tower structure is pivotably displaced about the connection member, such that the upper portion of the tower structure is displaced through the opening disposed in the roof proximate the back wall of the steel shipping container.

2. The mobile tower system of claim 1, wherein the horizontal frame includes:
a horizontal member extending between a first end opposite a second end, and
a channel disposed in the horizontal member and extending between the first end and the second end of the horizontal member,
wherein the connection member is moveably coupled in the channel such that the channel guides the connection member linearly along the horizontal member between the first end and the second end thereof when the tower structure is displaced from the substantially horizontal travel position to the substantially vertical operational position.

3. The mobile tower system of claim 2, wherein the horizontal member is a first horizontal member, the channel is a first channel disposed in the first horizontal member, and the connection member is a first connection member,
wherein the horizontal frame further includes:
a second horizontal member extending between a first end of the second horizontal member opposite a second end of the second horizontal member, and
a second channel disposed in the second horizontal member and extending between the first end and the second end of the second horizontal member, and
wherein the second connection member is moveably coupled in the second channel such that the second channel guides the second connection member linearly along the second horizontal member between the first end and the second end thereof when the tower structure is displaced from the substantially horizontal travel position to the substantially vertical operational position.

4. The mobile tower system of claim 3, wherein the first connection member is a first roller pin and the second connection member is a second roller pin.

5. The mobile tower system of claim 1, wherein the vertical frame includes:
a first portion fixed to the back wall of the shipping container, and
a second portion fixed to the first portion, the second portion being formed of a structurally continuous unit of sheet metal such that the second portion is defined by a first protrusion connected in parallel to a second protrusion, and
wherein when the tower structure is positioned in the substantially vertical operational position, the lower portion of the tower structure is positioned in the second portion of the vertical frame between the first protrusion and the second protrusion.

6. The mobile tower system of claim 5, further comprising a bracket attachable to the first protrusion and the second protrusion of the second portion of the vertical frame when the horizontal frame is removed from the vertical frame, the bracket holding the lower portion of the tower structure between the first protrusion and the second protrusion.

7. The mobile tower system of claim 1, further comprising a hydraulic cylinder mounted within the tower structure,
wherein when the tower structure is positioned in the substantially vertical operational position, the tower structure is extendable a vertical distance via the hydraulic cylinder.

8. A mobile tower system comprising:
a steel shipping container including:
a front wall opposite a back wall, and
a roof extending between the front wall and the back wall, the roof having an opening disposed in the roof proximate the back wall,
a tower structure having an upper portion and a lower portion, the tower structure moveable between a substantially horizontal travel position and a substantially vertical operational position;
a connection member fixed to the lower portion of the tower structure and moveably coupled to a channel, the channel disposed in a horizontal member removeably attached to a vertical frame attached to the back wall of the steel shipping container;
wherein when the tower structure is displaced from the substantially horizontal travel position to the substantially vertical operational position, the connection member and the tower structure are linearly displaced together along the channel toward the back wall and the tower structure is pivotably displaced about the connection member, such that the upper portion of the tower structure is displaced through the opening disposed in the roof proximate the back wall of the steel shipping container.

9. The mobile tower system of claim 8, wherein the horizontal member is a first horizontal member, the channel is a first channel disposed in the first horizontal member, the connection member is a first connection member, and the mobile tower system further including:
a second connection member fixed to the lower portion of the tower structure and moveably coupled to a second channel, the second channel disposed in a second horizontal member removeably attached to the vertical frame attached to the back wall of the steel shipping container, and
wherein when the tower structure is displaced from the substantially horizontal travel position to the substantially vertical operational position, the first and second connection members and the tower structure are linearly displaced together along the first and second channels toward the back wall and the tower structure is pivotably displaced about the first and second connection members, such that the upper portion of the tower structure is displaced through the opening disposed in the roof proximate the back wall of the steel shipping container.

10. The mobile tower system of claim 9, wherein the first connection member is a first roller pin and the second connection member is a second roller pin.

11. The mobile tower system of claim 8, wherein the vertical frame includes:
a first portion fixed to the back wall of the shipping container, and
a second portion fixed to the first portion, the second portion being formed of a structurally continuous unit of sheet metal such that the second portion is defined by a first protrusion connected in parallel to a second protrusion,
wherein when the tower structure is positioned in the substantially vertical operational position, the lower portion of the tower structure is positioned in the second portion of the vertical frame between the first protrusion and the second protrusion.

12. The mobile tower system of claim 11, further comprising a bracket attachable to the first protrusion and the second protrusion of the second portion of the vertical frame when the horizontal frame is removed from the vertical frame, the bracket holding the lower portion of the tower structure between the first protrusion and the second protrusion.

13. The mobile tower system of claim 11, wherein the first portion fixed to the back wall of the shipping container includes a prefabricated top portion fixed to a top half of the back wall and a prefabricated bottom portion fixed to a bottom half of the back wall.

14. The mobile tower system of claim 8, further comprising a hydraulic cylinder mounted within the tower structure, and
wherein when the tower structure is positioned in the substantially vertical operational position, the tower structure is extendable a vertical distance via the hydraulic cylinder.

15. A mobile tower system comprising:
a steel shipping container including:
a front wall opposite a back wall, and
a roof extending between the front wall and the back wall, the roof having an opening disposed in the roof proximate the back wall,
a tower structure having an upper portion and a lower portion, the tower structure moveable between a substantially horizontal travel position and a substantially vertical operational position;
a roller rotatably coupled to a pin, the pin fixed to the lower portion of the tower structure and the roller moveably coupled in a channel, the channel disposed in a horizontal member removeably attached to a vertical frame;
wherein when the tower structure is displaced from the substantially horizontal travel position to the substantially vertical operational position, the roller and the tower structure are linearly displaced together along the channel toward the back wall and the tower structure is pivotably displaced about the roller, such that the upper portion of the tower structure is displaced through the opening disposed in the roof proximate the back wall of the steel shipping container.

16. The mobile tower system of claim 15, wherein the horizontal member is a first horizontal member, the channel is a first channel disposed in the first horizontal member, the roller is a first roller, the pin is a first pin, and the mobile tower system further including:
a second roller rotatably coupled to a second pin, the second pin fixed to the lower portion of the tower structure and the second roller moveably coupled in a second channel, the second channel disposed in a second horizontal member removeably attached to the vertical frame,
wherein when the tower structure is displaced from the substantially horizontal travel position to the substantially vertical operational position, the first and second rollers and the tower structure are linearly displaced together along the first and second channels toward the back wall and the tower structure is pivotably displaced about the first and second rollers, such that the upper portion of the tower structure is displaced through the opening disposed in the roof proximate the back wall of the steel shipping container.

17. The mobile tower system of claim 15, wherein the vertical frame includes:
a first portion fixed to the back wall of the shipping container, and
a second portion fixed to the first portion, the second portion being formed of a structurally continuous unit of sheet metal such that the second portion is defined by a first protrusion connected in parallel to a second protrusion,
wherein when the tower structure is positioned in the substantially vertical operational position, the lower portion of the tower structure is positioned in the second portion of the vertical frame between the first protrusion and the second protrusion.

18. The mobile tower system of claim 17, further comprising a bracket attachable to the first protrusion and the second protrusion of the second portion of the vertical frame when the horizontal frame is removed from the vertical frame, the bracket holding the lower portion of the tower structure between the first protrusion and the second protrusion.

19. The mobile tower system of claim 17, wherein the first portion fixed to the back wall of the shipping container includes a prefabricated top portion fixed to a top half of the back wall and a prefabricated bottom portion fixed to a bottom half of the back wall.

20. The mobile tower system of claim 15, further comprising a hydraulic cylinder mounted within the tower structure, and
wherein when the tower structure is positioned in the substantially vertical operational position, the tower structure is extendable a vertical distance via the hydraulic cylinder.
